(19) United States
(12) Patent Application Publication
(10) Pub. No.: US 2007/0172637 A1
(43) Pub. Date: Jul. 26, 2007

(54) Decorative sheets having enhanced adhesion and penetration resistant laminates prepared therefrom

(76) Inventors: Richard A. Hayes, Beaumont, TX (US); Rebecca L. Smith, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/648,296

(22) Filed: Dec. 29, 2006

Related U.S. Application Data
(60) Provisional application No. 60/755,155, filed on Dec. 30, 2005.

(51) Int. Cl. B32B 27/32

(52) U.S. Cl. 428/220

(57) ABSTRACT

The present invention provides decorative sheets and laminate articles prepared therefrom, and processes for producing same. The decorative laminates provided herein offer penetration resistance comparable to some safety glass laminates.

### CROSS-REFERENCE TO RELATED APPLICATION

This application claims priority under 35 U.S.C. § 120 to U.S. Provisional Application No. 60/755,155, filed on Dec. 30, 2005, which is incorporated herein by reference in its entirety.

### FIELD OF THE INVENTION

This invention relates to decorated polymer sheets that exhibit enhanced adhesion to polymeric materials and glass. In addition, the invention relates to laminated structures having superior penetration resistance comprising at least one such sheet and to processes for producing such laminates.

### BACKGROUND OF THE INVENTION

Several patents and publications are cited in this description in order to more fully describe the state of the art to which this invention pertains. The entire disclosure of each of these patents and publications is incorporated by reference herein.

Glass laminates are widely used in the automotive and construction industries. A prominent application is in safety glass for automobile windshields. Safety glass is characterized by high impact and penetration resistance and typically consists of a laminate of two glass sheets bonded together with an interlayer of a polymeric film or sheet. One or both of the glass sheets may be replaced with optically clear rigid polymeric sheets, such as sheets of polycarbonate materials. More complex safety glass laminates include constructions composed of multiple layers of glass and polymeric sheets that are bonded together with interlayers of polymeric films or sheets.

A safety glass interlayer typically comprises a relatively thick polymer film or sheet that exhibits toughness and bondability and adheres to the glass in the event of a crack or impact. This prevents scatter of glass shards. Generally, the polymeric interlayer is characterized by a high degree of optical clarity and low haze. Resistance to impact, penetration and ultraviolet light is usually excellent. Other properties include long term thermal stability, excellent adhesion to glass and other rigid polymeric sheets, low ultraviolet light transmittance, low moisture absorption, high moisture resistance and excellent long term weatherability. Commonly used interlayer materials include multicomponent compositions based on polyvinyl butyral (PVB), polyurethane (PU), polyvinylchloride (PVC), linear low density polyethylenes prepared in the presence of metallocene catalysts, ethylene vinyl acetate (EVA), polymeric fatty acid polyamides, polyester resins, such as polyethylene terephthalate, silicone elastomers, epoxy resins, elastomeric polycarbonates, and the like.

A recent trend has been the use of glass laminated products known as architectural glass in the construction of homes and office structures. Newer products include those specifically designed to resist disasters. Some examples include hurricane resistant glass, theft resistant glazings and blast resistant glass laminated products. Certain of these products have strength sufficient to resist intrusion even if the glass laminate has been broken. Other products meet requirements for incorporation as structural elements within buildings, for example as glass staircases. Ethylene copolymer ionomer resins have found use as the glass laminate interlayer material in certain of these products, for example, hurricane resistant glass. Such ionomer resins offer significantly higher strength than other common interlayer materials, such as polyvinyl butyral and ethylene vinyl acetate materials. For example, U.S. Pat. No. 6,432,522 discloses that polyvinyl butyral resins have a modulus per ASTM Method D 638 of less than 34.5 MPa (5000 psi), EVA materials have a modulus of 5.2-6.2 MPa (750-900 psi), while copolyethylene ionomer resins have a modulus in the range of 235-552 MPa (34,000-80,000 psi). Various ethylene copolymer ionomer resins are disclosed in U.S. Pat. Nos. 3,264,272; 3,322,734; 3,328,367; 3,338,739; 3,344,014; 3,355,319; 3,404,134; 3,471,460; 4,619,973; 4,732,944 and 4,906,703. Ethylene copolymer ionomers have been used disclosed as interlayers in glass or other transparent material laminates in U.S. Pat. Nos. 3,762,988; 4,663,228 4,668,574; 4,799,346; 5,002,820; 5,344,513; 5,759,698; 5,763,062, 5,895,721; 6,114,046; 6,187,448; 6,238,801; 6,265,054; 6,353,042; and 6,432,522; in U.S. Published Patent Applications 2002/0155302 and 2003/0044579; in European Patent Publication 483 087 A1; and in PCT Published Patent Applications WO 99/58334, WO 00/64670, and WO 2004/011755. U.S. Pat. No. 6,150,028, discloses glass laminates which include ionomer resin interlayers and glass with solar control characteristics. WO 01/60604 discloses a laminated glazing which includes a transparent flexible plastic that reflects infra-red radiation bonded between a ply of ionomer resin and a ply of a polymer material.

It is known to include some form of image or decoration within the laminated glass product. U.S. Pat Nos. 3,973,058, 4,303,718, and 4,341,683 disclose processes for printing polyvinyl butyral sheet material, used as a component in laminated safety glass, with a solvent-based ink. Disclosures of tint bands are found for example, in U.S. Pat. Nos. 3,008,858; 3,346,526; 3,441,361; and 3,450,552; and in Japanese Patent 2053298.

Disclosures of decorative window films may be found, for example, in U.S. Pat. Nos. 5,049,433, 5,468,532, 5,505,801, and WO 83/03800 which disclose an architectural safety glass laminate comprising a plastic substrate provided with a decorative pattern.

Decorative glass laminates have been produced through the incorporation of decorated films. For example, U.S. Pat. No. 6,824,868, U.S. Patent Application Publication 2003/0203167 and International Application WO 03/092999 disclose an interlayer for laminated glass comprising a polymeric support film with at least one printed color image, a polymeric film bonded to the support film, an adhesive layer bonded to the polymeric support film opposite of the interface between the polymeric support film and the polymeric film and another adhesive layer bonded to the polymeric film opposite of the interface between the polymeric film and the support film. Other references disclosing laminates having printed layers include U.S. Patent Application Publication 2002/0119306, U.S. Patent Application Publication 2003/0091758, and European Patent 0 160 510. European Patent 1 129 844 discloses a composite stratified decorated glass and/or transparent plastic panel characterized in that it comprises first and second glass or transparent plastic panes and a film or sheet made from transparent plastic that bears a decoration. The decorated transparent film or sheet is placed between the two panes and is stably associated with the panes by means of layers of suitable adhesives applied to the panes by calendering or heat lamination. The adhesives include polyurethanes and polyvinyl butyrals. Coating primers, such as silane, polyurethane, epoxy, or acrylic primers may be used on the transparent plastic film.

Decorative glass laminates derived from printed interlayers are known in the art. For example, U.S. Pat. No. 4,968,553, discloses an architectural glass laminate that includes an interlayer of extruded polyurethane, wherein a non-solvent based ink containing solid pigments is printed on the polyurethane interlayer prior to lamination. For example, U.S. Pat. Nos. 4,173,672, 4,976,805, 5,364,479, 5,487,939, and 6,235,140 disclose a method for manufacture of decorated colored glass involving transfer of a color impression onto an adhesive polyvinyl butyral layer. Ink jet printing a temporary substrate and transfer printing the image onto a second substrate is disclosed in WO 95/06564 and WO 2004/039607.

Decorative printed polyvinyl butyral sheets for glass laminates are also known in the art, see, for example; U.S. Pat. No. 5,914,178. U.S. Patent Application Publication 2004/0187732 discloses an ink jet ink set comprising non-aqueous, colored, pigmented inks, at least one of which is a yellow ink comprising PY120 dispersed in a non-aqueous vehicle for the use of the printed substrate in preparation of laminated glass articles. U.S. Patent Application Publication 2004/0234735 and WO 02/18154 disclose a method of producing image carrying laminated material including the steps of forming an image on a first surface of a sheet of interlayer using solvent based ink, paint or dye systems, interposing the interlayer sheet between two sheets of material and joining the two sheets of material to form the laminate by activating the interlayer. WO 2004/011271 discloses a process for ink-jet printing an image onto a rigid thermoplastic interlayer comprising the steps of feeding a rigid interlayer sheet through an ink jet printer and ink jet printing an image on the sheet, wherein the interlayer has a Storage Young's Modulus of 50-1,000 MPa and wherein the rigid interlayer sheet has a finite thickness of less than or equal to about 0.38 mm. WO 2004/018197 discloses a process for obtaining an image-bearing laminate having a laminate adhesive strength of at least 1000 psi, which includes ink jet printing a digital image onto a thermoplastic interlayer selected from polyvinyl butyrals, polyurethanes, polyethylenes, polypropylenes, polyesters, and EVA using a pigmented ink which comprises at least one pigment selected from the group consisting of PY120, PY155, PY128, PY180, PY95, PY93, PV19/PR202, PR122, PR15:4, PB15:3, and PBI7.

One shortcoming of decorative laminates of the prior art is the low level of adhesion between the printed surface and the other laminate layers. The colorant has been considered to be the primary cause of this phenomenon. While strides have been made within the art to overcome this problem, greater laminate adhesion would be desirable for a wide array of end uses. The present invention addresses this issue and provides decorated laminates with excellent laminate adhesion as well as superior penetration resistance.

### SUMMARY OF THE INVENTION

The present invention is directed to a decorated polymer sheet. The present invention is particularly directed to a polymer sheet having upper and lower surfaces, and having a thickness of at least about 0.25 mm. The polymer sheet comprises a polymer composition that has a modulus of between about 20,000 psi (138 MPa) and about 100,000 psi (690 MPa), as determined according to ASTM D 638-03. At least one of the surfaces of the sheet has disposed thereon an image and an adhesive composition, and at least a portion of the adhesive composition is in contact with said image.

The present invention is further directed to a laminate comprising at least one layer comprising a decorated polymer sheet of the invention and at least one other layer.

The present invention is also directed to a process for preparing a laminate that includes at least one decorated polymer sheet of the invention and a second layer, the process comprising the steps of: (1) forming an image-bearing surface on a polymer sheet by applying an image to at least one surface of said polymer sheet; (2) applying an adhesive composition to at least a portion of said image-bearing surface; and (4) laminating the image-bearing surface to a second layer.

### DETAILED DESCRIPTION OF THE INVENTION

The definitions herein apply to the terms as used throughout this specification, unless otherwise limited in specific instances.

The term “modulus” as used herein, refers to a modulus that is measured in accord with ASTM Standard D 638-03.

The term “(meth)acrylic acid” as used herein refers to acrylic acid or methacrylic acid, or to a mixture of acrylic acid and methacrylic acid. The term “(meth)acrylate” as used herein refers to a salt or ester of acrylic acid, methacrylic acid, or of a mixture of acrylic acid and methacrylic acid.

The terms “finite amount” and “finite value”, as used herein, refer to an amount or value that is greater than zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and other factors that will be apparent to those of skill in the art. In general, an amount, size, formulation, parameter or other quantity or characteristic is “about” or “approximate” whether or not expressly stated to be such.

The term “or”, when used alone herein, is inclusive; more specifically, the phrase “A or B” means “A, B, or both A and B”. Exclusive “or” is designated herein by terms such as “either A or B” and “one of A or B”, for example.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

All percentages, parts, ratios, and the like set forth herein are by weight, unless otherwise limited in specific instances.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

The decorated sheet of the present invention comprises a polymer sheet. The polymer sheet comprises a polymer composition that has a modulus of between about 20,000 psi (138 MPa) and about 100,000 psi (690 MPa), as determined by ASTM Method D-638 to provide high laminate impact resistance and penetration resistance. Preferably, the polymer composition has a modulus of between about 25,000 psi (173 MPa), and about 90,000 psi (621 MPa), and more preferably, the decorated sheet comprises a polymer having a modulus of between about 30,000 psi (207 MPa), and about 80,000 psi (552 MPa). Preferably, the polymer sheet consists of or consists essentially of the polymer composition.

Preferred polymer compositions comprise one or more of an ethylene acid copolymer, a polyvinyl chloride and a polyurethanes. The ethylene acid copolymers preferably incorporate from between about 0.1 weight percent to about 30 weight percent or, still more preferably, from about 10 weight percent to about 25 weight percent of copolymerized residues having acid functionality, based on the total weight of the copolymer. Ethylene copolymers and ethylene copolymer ionomers that incorporate from about 15 weight percent to about 25 weight percent of copolymerized residues having acid functionality, based on the total weight of the polymer, are particularly preferred, because of their especially enhanced adhesion to glass.

The acid functionality is generally derived from copolymerized residues of one or more unsaturated carboxylic acids or unsaturated carboxylic acid anhydrides. Preferably, the acid functionality results from copolymerized units of carboxylic acids and carboxylic acid anhydrides including acrylic acid, methacrylic acid, itaconic acid, maleic acid, maleic anhydride, fumaric acid, monomethyl maleic acid, and mixtures thereof. Ethylene acid copolymers comprising copolymerized units of acrylic acid and methacrylic acid are especially preferred.

The ethylene acid copolymers may optionally contain copolymerized residues of one or more other unsaturated comonomers, such as acrylate esters. Preferably, the unsaturated comonomers are selected from the group consisting of methyl acrylate, methyl methacrylate, butyl acrylate, butyl methacrylate, glycidyl methacrylate, vinyl acetate, and mixtures thereof. Preferably, the ethylene acid copolymers incorporate a finite amount up to about 50 weight percent of the optional unsaturated comonomer or comonomers, based on the total weight of the ethylene copolymer. More preferably, the ethylene copolymers and ethylene copolymer ionomers a finite amount up to about 25 weight percent of the optional unsaturated comonomer, based on the total weight of the composition. Most preferably, the ethylene copolymers and ethylene copolymer ionomers incorporate a finite amount up to about 10 weight percent of the other unsaturated comonomer, based on the total weight of the composition. The ethylene acid copolymers may be prepared by copolymerization as disclosed, for example, in U.S. Pat. Nos. 3,404,134; 5,028,674; 6,500,888 and 6,518,365.

The ethylene acid copolymers may optionally be neutralized to form the corresponding ionomers. lonomers of ethylene acid copolymers are also suitable for use in the polymer composition, providing that the modulus of the polymer composition remains with in the suitable range. Neutralization levels may be low, i.e., below 1 percent, or high, including 100 percent neutralization, based on total carboxylic acid content. Neutralization will take place using metallic ions. The metallic ions may be monovalent or multivalent, including divalent and trivalent metallic ions. Mixtures of such ion classes may also be used. Preferable monovalent metallic ions include sodium, potassium, lithium, silver, mercury, copper, and the like and mixtures thereof. Preferable divalent metallic ions include beryllium, magnesium, calcium, strontium, barium, copper, cadmium, mercury, tin, lead, iron, cobalt, nickel, zinc, and the like and mixtures thereof. Preferable trivalent metallic ions include of aluminum, scandium, iron, yttrium, and the like and mixtures thereof. Other useful multivalent metallic ions include titanium, zirconium, hafnium, vanadium, tantalum, tungsten, chromium, cerium, iron, and the like and mixtures thereof. Preferably, when the metallic ion is multivalent, complexing agents that include stearates, oleates, salicylates, and phenolates are used. Such compositions are disclosed, for example in U.S. Pat. No. 3,404,134. Sodium, lithium, magnesium, zinc, aluminum, and mixtures thereof are especially useful metallic ions. Most preferably, the metallic ion is selected from the group consisting of sodium, zinc, and mixtures thereof. Sodium is most preferred due to high optical clarity of sheets comprising ethylene copolymer sodium ionomers. Zinc ionomers imparts high moisture resistance and is an especially useful metallic ion. Preferably, the ethylene acid copolymer ionomers will be neutralized from about 10 to about 90 percent with metallic ions based on the total carboxylic acid content. More preferably, the ethylene acid copolymer ionomers will be neutralized from about 20 to 80 percent with metallic ions based on the total carboxylic acid content. Processes for neutralization of ionomers are well known in the art, for example as disclosed in U.S. Pat. No. 3,404,134.

The ethylene acid copolymer composition in the polymeric sheet may optionally incorporate additives that act to reduce the melt flow of the resin. As will be familiar to those skilled in the art, such additives may be used in amounts that do not interfere with or prevent production of thermoset films and sheets. The use of such additives enhances the upper enduse temperature of the sheet and laminates made therefrom. Typically, the enduse temperature will be enhanced by 20° to 70° C. In addition, laminates produced from sheets that incorporate such additives will be more fire resistant than laminates wherein the sheets of the layers do not incorporate additives. By reducing the melt flow of the ethylene copolymer sheet, it will have a reduced tendency to melt and flow out of a laminate and, in turn, serve as additional fuel for a fire. Specific examples of melt flow reducing additives include organic peroxides, such as 2,5-dimethylhexane-2,5-dihydroperoxide, 2,5-dimethyl-2,5-di(tert-betylperoxy)hexane-3, di-tert-butyl peroxide, tert-butylcumyl peroxide, 2,5-dimethyl-2,5-di(tert-butylperoxy)hexane, dicumyl peroxide, alpha, alpha′-bis(tert-butyl-peroxyisopropyl)benzene, n-butyl-4,4-bis(tert-butylperoxy)valerate, 2,2-bis(tert-butylperoxy)butane, 1,1-bis(tert-butyl-peroxy)cyclohexane, 1,1-bis(tert-butylperoxy)-3,3,5-trimethyl-cyclohexane, tert-butyl peroxybenzoate, benzoyl peroxide, and the like and mixtures combinations thereof. Organic peroxides that decompose at temperatures of about 100° C. or higher are preferred. More preferably, the organic peroxides will have a decomposition temperature which affords a half life of 10 hours at about 70° C. or higher to provide improved stability for blending operations. Typically, the organic peroxides will be added at a level of up to about 10 weight percent based on the total weight of the ethylene copolymer composition. If desired, initiators, such as dibutyltin dilaurate, may be used. Typically, initiators are added at a level of up to about 0.05 weight percent based on the total weight of the ethylene copolymer composition. If desired, inhibitors, such as hydroquinone, hydroquinone monomethyl ether, p-benzoquinone, and methylhydroquinone, may be added for the purpose of enhancing control to the reaction and stability. Typically, the inhibitors would be added at a level of less than about 5 weight percent based on the total weight of the ethylene copolymer composition.

Specific preferred examples of the polymeric sheet materials include, for example, copolymers of ethylene and methacrylic acid and ionomers thereof, lotek® ionomer resins available from the Exxon Corporation, IMAC® ionomer resins available from the Chevron Corporation, certain poly(vinyl chloride) resins, certain impact-resistant, rigid polyurethane materials.

It is understood that the polymer composition may incorporate various additives known within the art. Such additives may include, for example, plasticizers, processing aids, flow enhancing additives, lubricants, colorants, pigments, dyes, flame retardants, impact modifiers, nucleating agents to increase crystallinity, antiblocking agents such as silica, thermal stabilizers, slip agents, UV absorbers, UV stabilizers, dispersants, surfactants, chelating agents, coupling agents, adhesives, primers and the like. The amount of a particular additive used will depend upon the type of additive and the particulars of the polymer composition. For example, a UV stabilizer level could be used at levels as low as 0.1 weight percent, while a plasticizer might be used at a level of more than 30 weight percent. Methods for selecting and optimizing the particular levels and types of additives for the polymers comprising the sheet material are known to those skilled in the art.

Colorants may be added to the polymer composition to provide pigmentation or to control the amount of transmitted solar light. Typical colorants may include any that are known in the art, for example a bluing agent to reduce yellowing.

The polymer sheet may be formulated to incorporate infrared absorbants, such as inorganic infrared absorbants, for example indium tin oxide (ITO) nanoparticles or antimony tin oxide (ATO) nanoparticles, and organic infrared absorbents, for example polymethine dyes, amminium dyes, imminium dyes, dithiolene-type dyes and phthalocyanine-type dyes and pigments. Methods for selecting and optimizing the particular levels and types of additives for the polymers comprising the sheet material are known to those skilled in the art.

Any known thermal stabilizer or mixture of thermal stabilizers may find utility in the polymer composition. Useful thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O—, N— and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like Generally, when used, thermal stabilizers will be present in the polymer composition in an amount of 0.001 to 10 weight percent based on the total weight of the polymer composition. Preferably, 0.001 to about 5.0 weight percent thermal stabilizers, based on the total weight of the composition will be used. More preferably 0.05 to about 1.0 weight percent thermal stabilizers, based on the total weight of the polymer composition will be used.

The polymer composition may contain a UV absorber or a mixture of UV absorbers. Preferable general classes of UV absorbers include benzotriazoles, hydroxybenzophenones, hydroxyphenyl triazines, esters of substituted and unsubstituted benzoic acids, and the like and mixtures thereof. Any UV absorber known within the art will find utility within the present invention. The polymer composition preferably incorporates from about 0.001 to about 10.0 weight percent UV absorbers, more preferably 0.001 to 5.0 weight percent, and still more preferably, 0.05 to 1.0 weight percent based on the total weight of the composition.

The polymer composition may also incorporate an effective amount of a hindered amine light stabilizer (HALS). Generally, HALS are understood to be secondary, tertiary, acetylated, N-hydrocarbyloxy substituted, hydroxy substituted N-hydrocarbyloxy substituted, or other substituted cyclic amines which further have some degree of steric hindrance, generally derived from aliphatic substitution on the carbon atoms adjacent to the amine function. When used, HALS are preferably present in amounts of from 0.001 to 10.0 weight percent, based on the total weight of the polymer composition, more preferably from 0.05 to 5.0 weight percent based on the total weight of the polymer composition, most preferably from 0.05 to 1.0 weight percent based on the total weight of the polymer composition.

The decorated polymeric sheet of the present invention has a thickness of about 0.38 mm (15 mils) or greater. This thickness provides enhanced penetration strength of laminates that incorporate the sheet as a layer. Preferably, the decorated polymeric sheet has a thickness of about 0.75 mm (30 mils) which thickness provides a further enhancement of penetration strength. Even more preferably, the polymeric sheets of the invention having a thickness of about 1.25 mm (50 mils) or greater to provide even further enhanced penetration strength. The enhanced penetration strength satisfies many requirements mandated for hurricane and threat resistance. Certain uses require laminate interlayers to be even thicker. Interlayers thicker than 60 mils (1.50 mm), 90 mils (2.25 mm), and even thicker than 120 mils (3.00 mm), are have been used for certain applications. Preferably, the decorated polymeric sheets incorporate rough surfaces to facilitate deairing during lamination processes.

The polymeric sheet may be formed by any of the processes known in the art, such as extrusion, calendering, solution casting or injection molding. Selection of the method and parameters will depend upon the viscosity characteristics of the polymeric material used and the desired thickness of the sheet. Preferably the polymeric sheet is formed by extrusion, especially for manufacture of “endless” products, such as films and sheets. In extrusion processes, which are typically conducted at melt temperatures of 50° C. to about 300° C., the polymeric material is fluidized and homogenized. Preferably, the melt processing temperature is from about 100° C. to about 250° C. Recycled polymeric compositions may be used along with the virgin polymeric compositions. The polymer composition is forced through a suitably shaped die to produce the desired cross-sectional sheet shape. Sheets of different widths and thickness may be produced through use of appropriate dies, for example slot dies or circular dies. Using extruders known in the art a sheet can be produced by extruding a layer of polymer over chilled rolls and then further drawing down the sheet to the desired size by means of tension rolls.

A sheeting calender is employed for manufacture of large quantities of sheets. If the sheet is required to have a textured surface, an appropriate embossing pattern may be applied through use of an embossing roller or an embossing calender.

The polymeric sheet may have a smooth surface, but preferably it will have a roughened surface to permit most of the air to be removed between layers during lamination processes. Surface roughening may be accomplished, for example, by mechanically embossing the sheet after extrusion or by melt fracture during extrusion of the sheet and the like. This rough surface is only temporary and particularly functions to facilitate deairing during laminating after which it is melted smooth as a result of the elevated temperature and pressure associated with autoclaving and other lamination processes. Surface patterns on the polymeric sheet are important parameters in facilitating deairing during the lamination process. An acceptable range of R_{z}, for the stiff, rigid polymeric sheet of the present invention have an acceptable is from about 5 to 15 micrometers.

The properties exhibited by a sheet will depend on many factors including the polymeric composition, the method of forming the polymer, the method of forming the sheet, and whether the sheet was treated for stretch or biaxially oriented. These factors affect many properties such as shrinkage, tensile strength, elongation at break, impact strength, dielectric strength and constant, tensile modulus, chemical resistance, melting point, heat deflection temperature, and the like.

The polymer sheets of the present invention may be further modified to provide valuable attributes to the sheets and to the laminates produced therefrom. For example, the sheets of the present invention may be treated by radiation, for example, electron beam treatment of the films and sheets. Electron beam treatment of the sheets of the present invention with an intensity in the range of about 2 MRd to about 20 MRd will provide an increase in the softening point of the sheet (Vicat Softening Point) of about 20° C. to about 50° C. Preferably, the radiation intensity is from about 2.5 MRd to about 15 MRd.

The sheet will have at least one image disposed on at least one surface, i.e. on the upper or lower surface of the sheet. Images may also be disposed on both the upper and lower surfaces of the sheet. The images may completely cover the sheet or they may be disposed on a smaller portion of the sheet. Depending on, the method of application of the image, the percent coverage of the sheet may be above 100 percent. That is, the coverage of the image is determined by the number of inks utilized within a particular ink set. This can include application by multistrikes on the same area. Generally this provides for up to 100 percent coverage on the polymeric sheet for each ink used within a certain ink set. Thus, for example, if application of the image takes place using an inkjet printer and the ink set includes three inks, up to 300 percent coverage is possible. The term “percent coverage”, as used herein, is not to be confused with the percentage of the surface that is occupied by the image. For example, an image may occupy essentially 100% of the sheet's surface, but the percent coverage may be 10%, as for a translucent display or the like. Alternatively, an image may occupy 10% of the sheet's surface, but the percent coverage of the image may be 300%, as for a small design with saturated colors. Preferably, the image is disposed on at least ten percent of the surface of at least one of said surfaces of said sheet. Also preferably, the image has a percent coverage of at least ten percent. One of ordinary skill in the art of inkjet printing would know how to determine the appropriate coverage for a given decorated sheet.

The image may be applied to the sheet by any known art method. Such methods may include, for example, air-knife, printing, painting, Dahlgren, flexo, gravure, spraying, thermal transfer print printing, silk screen, thermal transfer, inkjet printing or other art processes. The image may be, for example, a symbol, geometric pattern, photograph, alphanumeric character, and the like or a layer of ink. In addition, combinations of such images may be utilized.

Preferably, the image is applied to the sheet by a digital printing process. Such processes provide speed and flexibility. A major advantage of digital printing is the minimal setup times required to produce an image. Examples of digital printing processes include, for example, thermal transfer printing and inkjet printing.

Thermal transfer printing, which is a dry-imaging process that involves the use of a printhead containing many resistive heating elements that selectively transfer solid ink from a coated ribbon to a substrate, is often used in applications such as printing bar codes onto labels and tags.

More preferably, the image is applied to the polymer sheet through an ink jet printing process. Ink jet printing is used in applications including desktop publishing and digital photography. It is also suitable for printing on textiles and fabrics. Ink jet printing is typically a wet-imaging, non-contact process in which a vehicle or carrier fluid is energized to “jet” ink components from a printhead over a small distance onto a substrate. Ink jet technologies include continuous and drop-on-demand types, with the drop-on-demand printing being the most common. Ink jet printheads generally fall within two broad categories; thermal printheads, mainly used with aqueous inks, and piezo-electric printheads, mainly used with solvent inks. In one particularly useful embodiment, the image is printed onto the polymer sheet using a piezo-electric drop-on-demand digital printing process.

The type of ink used in ink jet application of the image to the polymer sheet is not critical. Any of the common ink jet type inks are suitable. The ink may be solvent based, often referred to in the art as a “non-aqueous vehicle”, which term refers to an ink vehicle that comprises one or more solvents that are non-aqueous or substantially free of water. Solvent based inks may also comprise a colorant that is dissolved, e.g., a dye. Solvents may be polar and/or nonpolar. Examples of polar solvents include, for example, alcohols, esters, ketones and ethers, particularly mono- and di-alkyl ethers of glycols and polyglycols such as monomethyl ethers of mono-, di- and tri-propylene glycols and the mono-n-butyl ethers of ethylene, diethylene, and triethylene glycols. Useful, but less preferred, polar solvents include, for example, methyl isobutyl ketone, methyl ethyl ketone, butyrolactone and cyclohexanone. Examples of nonpolar solvents include, for example, aliphatic and aromatic hydrocarbons having at least six carbon atoms and mixtures of such materials, including refinery distillation products and byproducts. Adventitious water may be carried into the ink formulation, generally at levels of no more than about 2-4 percent by weight. By definition, the term “non-aqueous ink” as used herein refers to an ink having no more than about 10 weight percent, and preferably no more than about 5 weight percent, of water based on the total weight of the non-aqueous vehicle.

The ink may also be aqueous or water based. Typically, aqueous inks comprise a colorant that is dispersed, e.g., a pigment. Combinations of solvent based and water based inks are also useful.

In addition to the colorant, an ink jet ink formulation may contain humectants, surfactants, biocides, and penetrants and other ingredients known to those skilled in the art.

The amount of the vehicle in the ink is typically in the range of about 70 weight percent to about 99.8 weight percent, and preferably about 80 weight percent to about 99.8 weight percent, based on the total weight of the ink.

Preferably, the ink includes a pigment. Pigment colorants have enhanced color fastness compared to dyes. They also exhibit excellent thermal stability, edge definition, and low diffusivity on the printed substrate. Preferably, however, solvent based ink is used as the ink jet ink due to the difference in dispersion properties. Standards of dispersion quality are high in ink jet printing processes. While pigments may be “well dispersed” for certain applications, dispersion may be inadequate for ink jet applications.

Preferably, the ink jet printing process allows for the use of flat sheet stock which is not stored or fed from rolls of sheet. The polymeric sheet of the present invention has a high modulus and tends to be too stiff to be rolled. This is especially true for polymeric sheet thicknesses of 0.75 mm (30 mils) or greater. The polymer sheet is preferably thick to provide penetration strength of high strength laminates that may be produced using the sheet as one or more layers of a laminate. It is further preferable that the polymeric sheet be thick to reduce the number of layers when the polymeric sheet is used in certain laminate applications. The greater thickness of the polymeric sheet further allows for a simplification of the printing process by significantly reducing or eliminating the need for backing layers or sacrificial webs to provide dimensional stability to the polymeric sheet during the printing process, while maintaining high quality images.

Ink jet printing processes which allow the use of flat sheet stock are well known. Generally, flat bed ink jet printers are utilized in such processes. Typically, the printing process is one of two general types. In one process, the flat sheet stock is moved across the printhead(s) during the printing process, generally through the use of rollers. In an alternative process, the printhead(s) move across a sheet stock that is immobilized in the flat bed. Examples of commercially-available, wide-format inkjet printers include the NUR Tempo® Modular Flatbed Inkjet Presses manufactured by NUR Microprinters of Monnachie, N.J. These are piezo drop-on-demand printers which may include up to 18 piezo drop-on-demand print heads.

Preferably, the ink set comprises at least three different, non-aqueous, colored pigmented inks (CMY), at least one of which is a magenta ink, at least one of which is a cyan ink, and at least one of which is a yellow ink dispersed in a non-aqueous vehicle. The yellow pigment preferably is chosen from the group consisting of Color Index PY120, PY155, PY128, PY180, PY95, PY93 and mixtures thereof. More preferably, the yellow pigment is Color Index PY120. A commercial example is PV Fast Yellow H2G (Clariant). This pigment has the advantageous color properties of favorable hue angle, good chroma, and light fastness and further disperses well in non-aqueous vehicle. Most preferably, the magenta ink comprises a complex of PV19 and PR202 (also referred to as PV19/PR202) dispersed in a non-aqueous vehicle. A commercial example is Cinquasia Magenta RT-255-D (Ciba Specialty Chemicals Corporation). The pigment particles can comprise an intimate complex of the PV19 and PR202 species, not simply a physical mixture of the individual PV19 and PR202 crystals. This pigment has the advantageous color properties of quinacridone pigments such as PR122 with favorable hue angle, good chroma, and light fastness and further disperses well in non-aqueous vehicle. In contrast, PR122 pigment does not disperse well under similar conditions. Also preferred is a cyan ink comprising PB 15:3 and/or PB 15:4 dispersed in a non-aqueous vehicle. Other preferable pigments include, for example, PR122 and PBI7. The ink set will commonly additionally include a non-aqueous, pigmented black ink, comprising a carbon black pigment. Preferably, the ink set comprises at least four inks (CMYK). The ink set may comprise a greater number of inks. For example, mixtures of six inks and eight inks are common.

Additional pigments for ink jet applications are generally well known. A representative selection of such pigments are found, for example, in U.S. Pat. Nos. 5,026,427; 5,086,698; 5,141,556; 5,169,436 and 6,160,370. The exact choice of pigment will depend upon color reproduction and print quality requirements of the application.

Generally, pigments are stabilized in a dispersion by employing dispersing agents, such as polymeric dispersants or surfactants. “Self-dispersible” or “self-dispersing” pigments (“SDP(s)”) have been developed that are dispersible in a vehicle without added dispersants. The dispersant can be a random or structured polymeric dispersant. Random polymers include acrylic polymers and styrene-acrylic polymers. Structured dispersants include AB, BAB and ABC block copolymers, branched polymers and graft polymers. Useful structured polymers are disclosed in, for example, U.S. Pat. Nos. 5,085,698 and 5,231,131 and in European Patent Application 0556649. Examples of typical dispersants for non-aqueous pigment dispersions include those sold under the trade names: Disperbyk (BYK-Chemie, USA), Solsperse (Avecia) and EFKA (EFKA Chemicals) polymeric dispersants. SDPs for non-aqueous inks include, for example, those described in U.S. Pat. No. 5,698,016; U.S. Published Patent Applications 2001003263; 2001004871 and 20020056403 and PCT Publication WO 01/94476.

It is desirable to use small pigment particles for maximum color strength and good jetting of ink. The particle size is generally in the range of from about 0.005 micron to about 15 microns, preferably in the range of about 0.01 to about 0.3 micron. The levels of pigment employed in the inks are typically in the range of from about 0.01 to about 10 weight percent, based on the total weight of the ink.

The solvent or aqueous inks may optionally contain one or more other ingredients such as surfactants, binders, bactericides, fungicides, algicides, sequestering agents, buffering agents, corrosion inhibitors, light stabilizers, anti-curl agents, thickeners, and/or other additives and adjuvants well know within the relevant art. The requirements of a particular ink jet printer to provide an appropriate balance of properties such as, for example, viscosity and surface tension, may be used to improve various properties or functions of the inks as needed. The amount of each ingredient is typically below about 15 weight percent and more typically below about 10 weight percent, based on the total weight of the ink. Useful surfactants include ethoxylated acetylene diols (e.g. Surfynols® series from Air Products), ethoxylated primary alcohols (e.g. Neodol® series from Shell) and secondary alcohols(e.g. Terigitol® series from Union Carbide), sulfosuccinates (e.g. Aerosol® series from Cytec), organosilicones (e.g. Silwet® series from Witco) and fluoro surfactants (e.g. Zonyl®) series from DuPont). Surfactants are typically utilized in amounts of about 0.01 to about 5 weight percent, preferably in amounts of about 0.2 to about 2 weight percent, based on the total weight of the ink.

The ink vehicle may also comprise a binder. Useful types of binders are soluble or dispersed polymer(s) added to the ink to improve the adhesion of a pigment. Examples include polyesters, polystyrene/acrylates, sulfonated polyesters, polyurethanes, polyimides, polyvinyl pyrrolidone/vinyl acetate (PVPNA), polyvinyl pyrrolidone (PVP) and mixtures thereof. Binders are generally used at levels of at least about 0.3 weight percent, preferably at least about 0.6 weight percent, based on the total weight of the ink. Upper limits are dictated by ink viscosity or other physical limitations, or by desired properties, such as ink drying time or a desired level of durability in the image.

Non-aqueous vehicles may also be comprised entirely or in part of polymerizable solvents, such as solvents which cure upon application of actinic radiation (actinic radiation curable) or UV light (UV curable). Specific examples of the radically polymerizable monomers and oligomers which may serve a components within such reactive solvent systems include, for example, vinyl monomers (meth)acrylate esters, styrene, vinyltoluene, chlorostyrene, vinyl acetate, allyl alcohol, maleic acid, maleic anhydride, maleimide, N-methylmaleimide (meth)acrylic acid, itaconic acid, ethylene oxide-modified bisphenol A, mono(2-(meth)acryloyloxyethyl) acid phosphate, phosphazene (meth)acrylate compounds, urethane (meth)acrylate compounds, prepolymers having at least one (meth)acryloyl group, polyester (meth)acrylates, polyurethane (meth )acrylates, epoxy(meth )acrylates, polyether (meth)acrylates, oligo(meth)acrylates, alkyd (meth)acrylates, polyol (meth)acrylates, silicone (meth )acrylates, tris[(meth )acryloyloxyethyl] isocyanu rate, saturated or unsaturated mixed polyester compounds of (meth)acrylic acid having one, two or more (meth)acryloyloxy groups in a molecule and the like and mixtures thereof.

Actinic radiation-curable compositions generally contain a minor amount of a photoinitiator. Specific examples include 1-hydroxycyclohexyl phenyl ketone, benzophenone, benzyl-dimethylketal, benzoin methyl ether, benzoin ethyl ether, p-chlorobenzophenone, 4-benzoyl-4-methyidiphenyl sulfide, 2-benzyl-2-dimethylamino-1-(4-morpholino-phenyl)butanone-1, 2-methyl-1-4-(methylthio)phenyl-2-morpholinopropanone-1, diethoxy acetophenone, and others. Photo-cationic polymerization initiators may also be employed. One or more photoinitiators may be added at a total level of from about 0.1 weight percent to about 20 weight percent based on the weight of total ink composition. Preferably from about 0.1 weight percent to about 15.0 weight percent of the photoinitiator is used based on the total weight of the ink composition.

Alternatively, the image may be formed from a photo-cationic-curable material. Generally, photo-cationically-curable materials incorporate epoxide and/or vinyl ether materials. The compositions may optionally include reactive diluents and solvents. Specific examples of preferable optional reactive diluents and solvents include epoxide-containing and vinyl ether-containing materials, for example; bis(2,3-epoxycyclopentyl)ether, 2,3-epoxy cyclopentyl glycidyl ether, 1,2-bis(2,3-epoxycyclopentyloxy)ethane, bis(4-hydroxycyclohexyl)methane diglycidyl ether and others. Any type of photoinitiator that forms cations that initiate the reactions of the epoxy and/or vinyl ether material(s) on exposure to actinic radiation can be used. There are a large number of suitable known cationic photoinitiators for epoxy and vinyl ether resins. They include, for example, onium salts with anions of weak nucleophilicity, halonium salts, iodosyl salts or sulfonium salts, such as are disclosed in EP 153904 and WO 98/28663, sulfoxonium salts, such as disclosed, for example, in EP 35969, EP44274, EP 54509, and EP 164314, ordiazonium salts, such as disclosed, for example, in U.S. Pat. Nos. 3,708,296 and 5,002,856. Other cationic photoinitiators are metallocene salts, such as disclosed, for example, in EP 94914 and EP 94915. A survey of other current onium salt initiators and/or metallocene salts can be found in “UV Curing, Science and Technology” (Editor S. P. Pappas, Technology Marketing Corp., 642 Westover Road, Stamford, Conn., U.S.A.) or “Chemistry & Technology of UV & EB Formulation for Coatings, Inks & Paints”, Vol. 3 (edited by P. K. T. Oldring). Specific examples of photo-cationic initiators include, for example; mixed triarylsulfonium hexafluoroantimonate salts (Cyracure® UVI-6974 and Cyracure® UVI-6990 photo-cationic initiators, available from the Union Carbide Company), diaryliodonium salts, such as the tetrafluoroborate, hexafluorophosphate, hexafluoroarsenate and hexafluoroantimonate salts, diphenyliodonium hexafluoroantimonate, triaryl sulfonium salts, such as tetrafluoroborate, hexafluorophosphate, hexafluoroarsenate and hexafluoroantimonate salts of triphenylsulfonium, 4-tertiarybutyltriphenylsulfonium, tris(4-methylphenyl)sulfonium, tris(4-methoxyphenyl)sulfonium, and 4-thiophenyltriphenylsulfonium, triphenylsulfonium hexafluorophosphate and the like and mixtures thereof.

When the ink contains a component that cures upon application of actinic radiation or UV light the polymer sheet bearing the applied image is irradiated with UV light or an electron beam to cure the image on the polymeric sheet. The source of actinic radiation may be selected from for example a low-pressure mercury lamp, high-pressure mercury lamp, metal halide lamp, xenon lamp, excimer laser, and dye laser for UV light, an electron beam accelerator and the like. The dose is usually in the range of 50-3,000 mJ/cm² for UV light and in the range of 0.2-1,000 mu C/cm² for electron beams.

Jet velocity, drop size and stability are greatly affected by the surface tension and the viscosity of the ink. Inkjet inks typically have a surface tension in the range of about 20 dyne/cm to about 60 dyne/cm at 25° C. Viscosity can be as high as 30 cP at 25° C. The inks have physical properties compatible with a wide range of ejecting conditions, i.e., driving frequency of the piezo element, or ejection conditions for a thermal head, for either a drop-on-demand device or a continuous device, and the shape and size of the nozzle. It is preferable that the ink (as an aqueous-based, non-aqueous-based, or mixture of an aqueous-based and non-aqueous-based vehicles) has a sufficiently low viscosity such that it can be jetted through the printing head of an ink jet printer without the necessity of heating the print head. It is, therefore, preferable for the ink viscosity to be below about 30 cP, as measured at 25° C. More preferably, the ink viscosity is below about 20 cP at 25° C. For drop-on-demand ink jet printers, it is preferable that the ink has a viscosity of above about 1.5 cP at 25° C. For drop-on-demand ink jet printers, it is more preferable that the ink has a viscosity of above about 1.7 cP at 25° C.

Any known ink jet printer process may be used to apply the decoration to the polymer sheet. Specific examples of ink jet printers include, for example, the HP Designjet inkjet printer, the Purgatory® inkjet printer, the Vutek UltraVu 3360 inkjet printer, and the like. Printing heads useful for piezo electric processes are available from, for example, Epson, Seiko-Epson, Spectra, XAAR and XAAR-Hitachi. Printing heads useful for thermal ink jet printing are available from, for example, Hewlett-Packard and Canon. Printing heads suitable for continuous drop printing are available, for example, from Iris and Video Jet.

Regardless of the process utilized to apply the image to the polymer sheet, an adhesive composition will be disposed on at least one surface, i.e. upper or lower surface, of the sheet. At least a portion of the adhesive composition will contact at least a portion of the image. The adhesive layer is preferably in the form of a coating, but it may also be a component of the image-forming composition, for example a component of an ink. When the adhesive/primer layer takes the form of an ink or coating, the adhesive/primer coating is less than 1 mil thick. Preferably, the adhesive/primer coating is less than 0.5 mil thick. More preferably, the adhesive/primer coating is less than 0.1 mil thick.

The adhesive or primer composition may comprise any adhesive known in the art. The adhesive or primer composition enhances the bond strength between the image disposed on the polymer sheet and other materials, particularly to another layer in a laminate structure. Mixtures of adhesives may also be utilized. Essentially any adhesive or primer known will find utility within the present invention.

Preferably, the adhesive composition is a silane which incorporates an amine function. Specific examples of such materials include, for example; gamma-aminopropyltriethoxysilane, N-beta-(aminoethyl)-gamma-aminopropyl-trimethoxysilane, and the like and mixtures thereof. Commercial examples of such materials include, for example A-1100® silane (available from the Silquest Company, and believed to be gamma-aminopropyltrimethoxysilane) and Z6020® silane (available from The Dow Chemical Company).

The adhesive composition may be applied to at least one surface of polymer sheet through melt processes or through a coating process, such as solution, emulsion, or dispersion coating. Appropriate process parameters will be known to those of ordinary skill in the art based on the type of adhesive composition used and process selected for the application of the adhesive to the polymer sheet surface. For example, when the ink does not comprise the adhesive composition, the adhesive composition may be cast, sprayed, air knifed, brushed, rolled, poured, printed or the like onto the polymer sheet surface after application of the image to the polymer sheet. Generally the adhesive composition will be diluted with a liquid prior to application and applied as a liquid medium to provide uniform coverage over the surface of the polymer sheet. The liquid may comprise one or more components and function as a solvent for the adhesive composition to form a solution or may function as a non-solvent for the adhesive composition to form a dispersion or emulsion. Usable liquids which may serve as solvents or non-solvents include those described above for the ink compositions.

The adhesive compositions useful in the present invention may also be applied by spraying a molten, atomized adhesive composition onto the polymer sheet surface. Such processes are disclosed within the art for wax coatings in, for example, in U.S. Pat. Nos. 5,078,313; 5,281,446, and 5,456,754.

The present invention is also directed to a laminate comprising a decorated polymer sheet of the invention and at least one additional layer. The additional layer will generally and preferably be in contact with a surface of the decorated polymer sheet upon which an image and adhesive composition are disposed. The additional layer may be selected from a wide variety of materials, such as polymers and glass. For example, the additional layer may comprise another polymeric sheet, an uncoated polymeric film such as biaxially oriented poly(ethylene terephthalate) film, an other coated polymeric film, or a rigid sheet, such as glass. The thickness of the polymeric film is not critical and may be varied depending on the particular application. Generally, the thickness of the polymeric film will range from about 0.1 mils (0.003 mm), to about 10 mils (0.26 mm). For automobile windshields, the polymeric film thickness may be preferably within the range of about 1 mil (0.025 mm), to about 4 mils (0.1 mm).

Examples of polymeric sheets and films include those produced from materials with a modulus of 138 MPa (20,000 psi) or less as measured by ASTM D 638-03. Materials with a modulus greater than 138 MPa may also be used as the additional layer. The additional layer polymeric film and sheets may provide the laminate with additional attributes, such as acoustical barriers. Polymeric films and sheets which provide acoustical dampening include, for example, ethylene vinyl acetate copolymer compositions, ethylene methyl acrylate copolymers, plasticized polyvinyl chloride compositions, metallocene-catalyzed polyethylene compositions, polyurethanes, polyvinyl butyral compositions, highly plasticized polyvinyl butyral compositions, acoustic modified poly(vinyl acetal) compositions, silicone/acrylate (“ISD”) resins, and the like. Such “acoustic barrier ” resins are disclosed within, for example, U.S. Pat. Nos. 5,368,917; 5,624,763; 5,773,102; and 6,432,522. Preferably, the additional layer polymeric film or sheet is selected from the group consisting of polycarbonate, polyurethane, acrylic sheets, polymethylmethacrylate, polyvinyl chloride, polyester, poly(vinyl butyral) compositions, poly(ethylene-co-vinyl acetate) compositions, poly(ethylene-co-(meth)acrylic acid) ionomers and biaxially oriented poly(ethylene terephthalate). The polymeric films and sheets may additionally comprise functional coatings applied to them, such as organic infrared absorbers and sputtered metal layers, such as silver, coatings and the like. Metal coated polymeric films and sheets are disclosed in, for example, U.S. Pat. Nos. 3,718,535; 3,816,201; 4,465,736; 4,450,201; 4,799,745; 4,846,949; 4,954,383; 4,973,511; 5,071,206; 5,306,547; 6,049,419; 6,104,530; 6,204,480; 6,255,031 and 6,565,982. Adhesives or primers may be added as optional ingredients, especially to provide additional adhesion between the other polymeric layer and the polymer sheet of the present invention.

Rigid sheet layers are usable as additional layers and can comprise glass or rigid transparent plastic sheets, such as, for example, polycarbonate, acrylics, polyacrylate, cyclic polyolefins, such as ethylene norbornene polymers, metallocene-catalyzed polystyrene and the like. Combinations of such materials may also be used. Metal or ceramic plates may be substituted for the rigid polymeric sheet or glass if clarity is not required in the laminate.

The term “glass”, as used herein, includes not only window glass, plate glass, silicate glass, sheet glass, and float glass, but also colored glass, specialty glass which includes ingredients to control, for example, solar heating, coated glass having disposed thereon, for example, sputtered metals, such as silver or indium tin oxide, for solar control purposes, E-glass, Toroglass, Solex® glass and the like. Such specialty glasses are disclosed in, for example, U.S. Pat. Nos. 4,615,989; 5,173,212; 5,264,286; 6,150,028; 6,340,646; 6,461,736; and 6,468,934. The type of glass to be selected for a particular laminate depends on the intended use.

The laminates of the present invention may optionally include additional layers, such as other polymeric sheets, other uncoated polymeric films, such as biaxially oriented poly(ethylene terephthalate) film, and other coated polymeric films. Examples of other polymeric sheets would include those produced from materials with a modulus of 20,000 psi (138 MPa), or less as measured by ASTM Method D 638-03 or greater than 20,000 psi. Adhesives or primers may also be present on laminate layers.

Preferred embodiments include laminate constructions which incorporate at least one decorated polymer sheet layer of the invention and at least one film layer; laminates which incorporate at least one decorated polymer sheet layer of the invention and at least two film layers; laminates which incorporate at least one decorated polymer sheet layer of the invention, at least one other sheet layer and at least one film layer; laminates which incorporate at least one rigid sheet layer, at least one decorated polymer sheet layer of the invention and at least one film layer; laminates which incorporate at least one rigid sheet layer, at least one decorated polymer sheet layer of the invention, at least one other sheet layer and at least one film layer; laminates which incorporate at least two rigid sheet layers and at least one certain decorated polymer sheet layer of the invention; laminates which incorporate at least two rigid sheet layers, at least one decorated polymer sheet layer of the invention and at least one other sheet layer; and laminates which incorporate at least two rigid sheet layers, at least one decorated sheet layer of the invention, at least one other sheet layer and at least one film layer.

The laminate layers (also known as plies) may be combined during extrusion or finishing processes resulting in production of laminates with improved physical characteristics. Five or more separate layers are not uncommon. Adhesive, or tie layers are often present in such laminates.

The processes which may be used to produce the laminates of the present invention are numerous and various. In the simplest process, the decorated polymer sheet of the invention is contacted with a second glass or polymer sheet, for example by laying the second sheet atop the surface of the polymer sheet of the invention upon which the image and adhesive is disposed.

Typically, pressure will be applied during formation of the laminate. One process useful to produce a laminate comprising the decorated polymeric sheet of the invention laminated to a polymeric film (coated or uncoated) comprises steps of lightly bonding the sheet to the film through a nip roll bonding process. In such a process, polymeric film is supplied from a roll and first passes over a tension roll. The film may be subjected to moderate heating by passing through a heating zone, such as an oven. The decorated polymeric sheet may also be supplied from a roll or as sheet stock and will typically first pass over a tension roll. The decorated polymeric sheet may be subjected to moderate heating by passing through a heating zone, such as an oven. Heating the film and sheet to a temperature sufficient to promote temporary fusion bonding, i.e.; to cause the surfaces of the decorated polymeric sheet to become tacky, is useful. Suitable temperatures for the decorated polymeric sheets of the invention will be within the range of about 50° C. to about 120° C., with the preferred surface temperatures reaching about 65° C. The film is fed along with the decorated polymeric sheet through nip rolls where the two layers are merged together under moderate pressure to form a weakly bonded laminate. If desired, the nip rolls may be heated to promote the bonding process. The bonding pressure exerted by the nip rolls may vary with the film materials, the decorated polymeric sheet materials, and the temperatures employed. Generally the bonding pressure will be within the range of about 10 psi (0.7 kg/sq cm), to about 75 psi (5.3 kg/sq cm), and is preferably within the range of about 25 psi (1.8 kg/sq cm), to about 30 psi (2.1 kg/sq cm). The tension of the decorated polymeric sheet/film laminate is controlled by passage over an idler roll. Typical line speeds through the roll assembly are within the range of about 5 feet (1.5 m), to about 30 feet (9.2 m), per minute. Proper control of the speed and the tension tends to minimize wrinkling of the film. After bonding, the laminate is passed over a series of cooling rolls which ensure that the laminate taken up on a roll is not tacky. Tension within the system may be further maintained through the use of idler rolls. Laminates made according to this process will have sufficient strength to allow handling by laminators who may produce further laminates, such as glass laminates, which encapsulate this two-layer laminate. This process may be modified to produce a wide variety of laminate types. For example, the film may be encapsulated between the decorated polymeric sheet of the invention and another polymeric sheet by the addition of another polymeric sheet to the above process; the decorated polymeric sheet may be encapsulated between two polymeric films by the addition of a second film; the decorated polymeric sheet may be encapsulated between a polymeric film and an other polymeric sheet through the addition of an other polymeric sheet; and so forth. Adhesives and primers may be used to enhance the bond strength between the laminate layers, if desired.

The laminates of the present invention may also be produced through autoclave and non-autoclave processes. For example, a laminate of glass and a decorated polymeric sheet of the present invention may be produced as follows by a conventional autoclave process known in the art. A glass sheet, a decorated polymer sheet of the invention and a second glass sheet are laminated together under heat and pressure and vacuum (for example, in the range of about 27-28 inches (689-711 mm) Hg) to remove air. Preferably, the glass sheets have been washed and dried. A typical glass type is 90 mil thick annealed flat glass. In a typical procedure, the decorated polymer sheet of the present invention is positioned between two glass plates to form a glass/decorated polymer sheet/glass assembly, the assembly is placed into a bag capable of sustaining a vacuum (“a vacuum bag”), the air is drawn out of the bag using a vacuum line, the bag is sealed while maintaining the vacuum and the sealed bag is placed in an autoclave at a temperature of about 130° C. to about 180° C., at a pressure of about 200 psi (15 bars), for from about 10 to about 50 minutes. Preferably the bag is autoclaved at a temperature of from about 120° C. to about 160° C. for 20 minutes to about 45 minutes. More preferably, the bag is autoclaved at a temperature of from about 135° C. to about 160° C. for 20 minutes to about 40 minutes. Most preferably, the bag is autoclaved at a temperature of from about 145° C. to about 155° C. for 25 minutes to about 35 minutes. A vacuum ring may be substituted for the vacuum bag. One type of vacuum bag is disclosed in U.S. Pat. No. 3,311,517. Alternatively, other processes may be used to produce the laminates of the present invention. Any air trapped within the glass/polymer sheet/glass assembly may be removed through a nip roll process. For example, the glass/polymer sheet/glass assembly may be heated in an oven at between about 80° C. and about 120° C., preferably between about 90° C. and about 100° C., for about 30 minutes. Thereafter, the heated glass/polymer sheet/glass assembly is passed through a set of nip rolls so that air in the void spaces between the glass and the polymer may be squeezed out, and the edge of the assembly sealed. This type of assembly is commonly referred to in the art as a pre-press. The pre-press may then placed in an air autoclave where the temperature is raised to between about 120° C. and about 160° C., preferably between about 135° C. and about 160° C., and pressure to between about 100 psig to about 300 psig, preferably about 200 psig (14.3 bar). These conditions are maintained for about 15 minutes to about 1 hour, preferably about 20 minutes to about 50 minutes, after which, the air is cooled and no further air is added to the autoclave. After about 20 minutes of cooling, venting occurs and the laminates are removed from the autoclave.

The laminates of the present invention may also be produced through non-autoclave processes. Such non-autoclave processes are disclosed, for example, in U.S. Pat. Nos. 3,234,062; 3,852,136; 4,341,576; 4,385,951; 4,398,979; 5,536,347; 5,853,516; 6,342,116; 5,415,909; U.S. Published Patent Application 2004/0182493, European Patent 1 235 683 B1, PCT Publication WO 91/01880 and PCT Publication WO 03/057478 A1. Generally, non-autoclave processes include heating the pre-press assembly and the application of vacuum, pressure or both. For example, the pre-press may be successively passed through heating ovens and nip rolls.

As one skilled in the art will appreciate, the above processes may be easily modified to make a wide variety of laminates. For example, laminates which incorporate at least one rigid sheet layer, at least one certain decorated sheet layer and at least one film layer; laminates which incorporate at least one rigid sheet layer, at least one certain decorated sheet layer, at least one other sheet layer and at least one film layer; laminates which incorporate at least two rigid sheet layers and at least one certain decorated sheet layer; laminates which incorporate at least two rigid sheet layers, at least one certain decorated sheet layer and at least one other sheet layer; laminates which incorporate at least two rigid sheet layers, at least one certain decorated sheet layer, at least one other sheet layer and at least one film layer; and the like may be produced. Within any of the above examples, the rigid sheets may be substituted independently for any other type of rigid sheet. These embodiments may be produced according to any of the non-autoclave processes described herein.

The decorated polymer sheets and laminates of the present invention are useful in glazing applications such as: architectural glass; signage; privacy glass; decorative glass walls; decorative glass dividers; windows in buildings; windshields and sidelites in automobiles, planes, trains and the like; structural support units such as stairs, floors, walls, partitions; other architectural units such as ceilings. Laminates of the present invention are particularly useful in applications where high strength and high penetration resistant safety glass is desirable or required. One of ordinary skill in the art of glazing manufacture, or glass lamination for safety glass applications would know and appreciate the various uses and applications of the resins and laminates described herein.

The following examples are presented for illustrative purposes only, and are not intended to limit the scope of the invention in any manner.

### EXAMPLES

### Example 1

An ink set is prepared that consists of the ink formulations shown in Table I where percentages are based on the total weight of the ink formulation. The pigment dispersion compositions and preparations are as disclosed in the Examples of U.S. Published Patent Application 2004/0187732.

TABLE I

| | |
|---|---|
| Magenta | 36.08 wt. % of a magenta pigment dispersion |
| | (7 wt. % pigment) |
| | 38.35 wt. % Dowanol ® DPMA¹ |
| | 25.57 wt. % Dowanol ® DPnP¹ |
| Yellow | 35.23 wt. % of a yellow pigment dispersion |
| | (7 wt. % pigment) |
| | 38.86 wt. % Dowanol ® DPMA¹ |
| | 25.91 wt. % Dowanol ® DPnP¹ |
| Cyan | 28.35 wt. % of a cyan pigment dispersion |
| | (5.5 wt. % pigment) |
| | 42.99 wt. % Dowanol ® DPMA¹ |
| | 28.66 wt. % Dowanol ® DPM¹ |
| Black | 27.43 weight percent of a black pigment dispersion |
| | (7 weight percent pigment) |
| | 43.54 weight percent Dowanol ® DPMA¹ |
| | 29.03 weight percent Dowanol ® DPM¹ |

¹Available from The Dow Chemical Company

Using the above mentioned ink set, an image is applied to a 30 mil thick (0.75 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 25%. An adhesive composition consisting of a solution of A-1100 silane (0.05 wt. %, based on the total weight of the solution, a product of the Silquest Company, believed to be gamma-aminopropyltrimethoxysilane), isopropanol (66.63 wt. %, based on the total weight of the solution) and water (33.32 wt. %, based on the total weight of the solution) is prepared and allowed to sit for at least one hour prior to use. A 12-inch by 12-inch piece of the decorated SentryGlas® Plus sheet is dipped into the silane solution (residence time approximately 1 minute), removed and allowed to drain and dry under ambient conditions to form a decorated polymer sheet. A glass laminate composed of a first glass layer, the decorated polymer sheet and a second glass layer is produced as follows. The decorated polymer sheet (12 inches by 12 inches (305 mm×305 mm)) is conditioned at 23% relative humidity (RH) at a temperature of 72° F. overnight. The laminate is prepared by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked such that the glass tin surface is in contact with the SentryGlas® Plus sheet. The glass/decorated polymer sheet/glass laminate is then placed into a vacuum bag and heated to 90°-100° C. for 30 minutes to remove any air contained between the glass/decorated polymer sheet/glass laminate layers, forming a pre-press assembly. The pre-press assembly is then subjected to autoclaving at 135° C. for 30 minutes in an air autoclave to a pressure of 200 psig (14.3 bar). The air is then cooled and no further air is introduced to the autoclave. After 20 minutes of cooling and when the air temperature in the autoclave is less than about 50° C. the autoclave is vented and the autoclaved glass/decorated polymer sheet/glass laminate is removed.

### Example 2

Using a pigmented 4-color CMYK UV-curable inkset available from NUR Microprinters, an image is applied to a 60 mil thick (1.50 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 50%. An adhesive composition consisting of a solution of A-1100 silane (0.05 wt. % based on the total weight of the solution, a product of the Silquest Company, believed to be gamma-aminopropyltrimethoxysilane), acetic acid (0.01 wt. % based on the total weight of the solution), isopropanol (66.63 wt. % based on the total weight of the solution) and water (33.31 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a first glass layer, the decorated polymer sheet and a second glass layer is produced in the following manner. The decorated polymer sheet (12 inches by 12 inches (305 mm×305 mm)) is conditioned at 23% relative humidity (RH) at a temperature of 72° F. overnight. A laminate is prepared by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked such that the glass tin surface is in contact with the SentryGlas® Plus sheet. The glass/decorated polymer sheet/glass laminate is then placed into a vacuum bag and heated to 90°-100° C. for 30 minutes to remove any air contained between the glass/decorated polymer sheet/glass laminate layers, forming a pre-press assembly. The pre-press assembly is then subjected to autoclaving, cooling and removal from the autoclave as described in Example 1 to produce an autoclaved glass/decorated polymer sheet/glass laminate.

### Example 3

Using a pigmented 4-color CMYK UV-curable inkset and a UV-curable white ink available from NUR Microprinters, an image is applied to a 90 mil thick (2.25 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 100%. An adhesive composition consisting of a solution of A-1100 silane (0.025 wt. % based on the total weight of the solution, a product of the Silquest Company, believed to be gamma-aminopropyltrimethoxysilane) isopropanol (66.65 wt. % based on the total weight of the solution) and water (33.32 wt. % based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet and a glass layer is produced, including conditioning of the polymer sheet, as described in Example 2. The laminate is produced by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked such that the glass tin surface is in contact with the SentryGlas® Plus sheet. The glass/decorated polymer sheet/glass laminate is treated in a vacuum bag as described in Example 2 to remove any air contained between the glass/decorated polymer sheet/glass laminate layers, forming a pre-press assembly. The pre-press assembly is then subjected to autoclaving, cooling and removal from the autoclave as described in Example 1 to produce an autoclaved glass/decorated polymer sheet/glass laminate.

### Example 4

Using a pigmented 4-color CMYK UV-curable inkset and a UV-curable white ink available from NUR Microprinters, an image is applied to a 120 mil thick (3.00 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 200%. An adhesive composition consisting of a solution of A-1100 silane (0.10 wt. % based on the total weight of the solution, a product of the Silquest Company, believed to be gamma-aminopropyltrimethoxysilane), acetic acid (0.01 wt. % based on the total weight of the solution) isopropanol (66.59 wt. % based on the total weight of the solution) and water (33.30 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a first glass layer, the decorated polymer sheet and a second glass layer is produced, including conditioning of the polymer sheet, as described in Example 2. The laminate is produced by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked such that the glass tin surface is in contact with the SentryGlas® Plus sheet. The glass/decorated polymer sheet/glass laminate is then treated in a vacuum bag as described in Example 2 to remove any air contained between the glass/decorated polymer sheet/glass laminate layers, forming a pre-press assembly. The pre-press assembly is then subjected to autoclaving, cooling and removal from the autoclave as described in Example 1 to produce a glass/decorated polymer sheet/glass laminate.

### Example 5

Using a pigmented 8-color CMYK UV-curable inkset available from NUR Microprinters, an image is applied to a 30 mil thick (75 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 400%. An adhesive composition consisting of a solution of A-1100 silane (0.05 wt. % based on the total weight of the solution, a product of the Silquest Company, believed to be gamma-aminopropyltrimethoxysilane), isopropanol (66.63 wt. % based on the total weight of the solution), and water (33.32 wt. % based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a first glass layer, the decorated polymer sheet and a second glass layer is produced, including conditioning of the polymer sheet, as described in Example 2. The laminate is produced by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked such that the glass tin surface is in contact with the SentryGlas® Plus sheet. The glass/decorated polymer sheet/glass laminate is then treated in a vacuum bag as described in Example 2 to remove any air contained between the glass/decorated polymer sheet/glass laminate layers, forming a pre-press assembly. The pre-press assembly is then subjected to autoclaving, cooling and removal from the autoclave as described in Example 1 to produce an autoclaved glass/decorated polymer sheet/glass laminate.

### Example 6

Using the ink set of Example 1, an image is applied to a 60 mil thick (1.50 mm) SentryGlas® Plus sheet by ink jet printing with a NUR Tempo® Modular Flatbed Inkjet Press equipped to handle rigid sheet stock (manufactured by NUR Microprinters of Monnachie, N.J.) to provide an ink coverage of 300%. An adhesive composition consisting of a solution of A-1100 silane (0.05 wt. % based on the total weight of the solution, a product of the Silquest Company, believed to be gamma-aminopropyltrimethoxysilane), acetic acid (0.01 wt. % based on the total weight of the solution), isopropanol (66.63 wt. % based on the total weight of the solution) and water (33.31 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a first glass layer, the decorated polymer sheet and a second glass layer is produced, including conditioning of the polymer sheet, as described in Example 2. The laminate is formed by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked such that the glass tin surface is in contact with the SentryGlas® Plus sheet. The glass/decorated polymer sheet/glass laminate is then treated in a vacuum bag as described in Example 2 to remove any air contained between the glass/decorated polymer sheet/glass laminate layers, forming a pre-press assembly. The glass/decorated polymer sheet/glass pre-press assembly is then subjected to autoclaving, cooling and removal from the autoclave as described in Example 1 to produce an autoclaved glass/decorated polymer/glass laminate.

### Example 7

Using a pigmented 6-color CMYK+|c|m UV-curable inkset and a UV-curable white ink, available from NUR Microprinters, an image is applied to a 90 mil thick (2.25 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 500%. An adhesive composition consisting of a solution of A-1100 silane (0.05 wt. % based on the total weight of the solution, a product of the Silquest Company, believed to be gamma-aminopropyltrimethoxysilane), isopropanol (66.63 wt. % based on the total weight of the solution) and water (33.32 wt. % based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a first glass layer, the decorated polymer sheet and a second glass layer is produced in the following manner. The decorated polymer sheet (12 inches by 12 inches (305 mm×305 mm) is produced, including conditioning, as described in Example 2. The laminate is produced by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked so that the glass tin surface is in contact with the SentryGlas® Plus sheet. The glass/decorated polymer sheet/glass laminate is then placed into a vacuum bag and heated to 90°-100° C. for 30 minutes to remove any air contained between the glass/decorated polymer sheet/glass laminate layers to form a pre-press assembly. The pre-press assembly is then subjected to autoclaving, cooling and removal from the autoclave as described in Example 1 to produce an autoclaved glass/decorated polymer sheet/glass laminate.

### Example 8

Using a pigmented 8-color CMYK+|c|my|k UV-curable inkset available from NUR Microprinters, an image is applied to a 120 mil thick (3.00 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 600%. An adhesive composition consisting of a solution of A-1100 silane (0.05 wt % based on the total weight of the solution, a product of the Silquest Company, believed to be gamma-aminopropyltrimethoxysilane), acetic acid (0.01 weight percent based on the total weight of the solution), isopropanol (66.63 wt. % based on the total weight of the solution) and water (33.31 wt. percent based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet and a second glass layer is produced in the following manner. The decorated polymer sheet (12 inches by 12 inches (305 mm×305 mm)), is conditioned at 23% relative humidity (RH) at a temperature of 72° F. overnight. The laminate is produced by stacking a clear annealed float glass plate layer (12 inches by 12 inches (305 mm×305 mm) by 2.5 mm thick), the decorated polymer sheet layer and a clear annealed float glass plate layer (12 inches by 12 inches (305 mm×305 mm) by 2.5 mm thick). The layers are stacked such that the glass tin surface is in contact with the SentryGlas® Plus sheet. The glass/decorated polymer sheet/glass laminate is then placed into a vacuum bag and heated to 90°-100° C. for 30 minutes to remove any air contained between the glass/decorated polymer sheet/glass laminate layers to form a pre-press assembly. The pre-press assembly is then subjected to autoclaving, cooling and removal from the autoclave as described in Example 1 to produce an autoclaved glass/decorated polymer sheet/glass laminate.

### Example 9

Using the ink set of Example 1, an image is applied to a 30 mil thick (0.75 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 50%. An adhesive composition consisting of a solution of A-1100 silane (0.05 wt. % based on the total weight of the solution, a product of the Silquest Company, believed to be gamma-aminopropyltrimethoxysilane), isopropanol (66.63 wt. % based on the total weight of the solution) and water (33.32 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet, an additional SentryGlas® Plus sheet and a glass layer is produced in the following manner. The decorated polymer sheet (12 inches by 12 inches (305 mm×305 mm), and the additional SentryGlas® Plus sheet (12 inches by 12 inches (305 mm×305 mm) by 30 mils thick (0.75 mm)) are conditioned at 23% relative humidity (RH) at a temperature of 72° F. overnight. The laminate is produced by stacking a clear annealed float glass plate layer (12 inches by 12 inches (305 mm×305 mm) by 2.5 mm thick), the decorated polymer sheet layer, the additional SentryGlas® Plus sheet and a clear annealed float glass plate layer (12 inches by 12 inches (305 mm×305 mm) by 2.5 mm thick). The layers are stacked such that the glass tin surface of the first glass layer is in contact with the undecorated surface of the decorated layer, the decorated surface of decorated layer is in contact with the additional SentryGlase Plus sheet and the glass tin surface of the second sheet is in contact with the other surface of the additional SentryGlas® Plus sheet. The glass/decorated polymer sheet/additional SentryGlas® Plus sheet layer/glass laminate is then placed into a vacuum bag and heated to 90°-100° C. for 30 minutes to remove any air contained between the glass/decorated polymer sheet/additional SentryGlas® Plus sheet layer/glass laminate layers to form a pre-press assembly. The pre-press assembly is then subjected to autoclaving, cooling and removal from the autoclave as described in Example 1 to produce an autoclaved glass/decorated polymer sheet/additional SentryGlas® Plus sheet layer/glass laminate.

### Example 10

Using a pigmented 4-color CMYK UV-curable inkset available from NUR Microprinters, an image is applied to a 60 mil thick (150 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 100%. An adhesive composition consisting of a solution of A-1100 silane (0.05 wt. % based on the total weight of the solution, a product of the Silquest Company, believed to be gamma-aminopropyltrimethoxysilane), acetic acid (0.01 weight percent based on the total weight of the solution), isopropanol (66.63 wt. % based on the total weight of the solution) and water (33.31 wt. % based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer, an additional SentryGlas® Plus sheet and a glass layer is produced in the following manner. The decorated polymer sheet (12 inches by 12 inches (305 mm×305 mm)) and the additional SentryGlas® Plus sheet (12 inches by 12 inches (305 mm×305 mm) by 60 mils thick (1.50 mm)) are conditioned at 23% relative humidity (RH) at a temperature of 72° F. overnight. The laminate is produced by stacking a clear annealed float glass plate layer (12 inches by 12 inches (305 mm×305 mm) by 2.5 mm thick), the decorated polymer sheet layer, the additional SentryGlas® Plus sheet layer and a clear annealed float glass plate layer (12 inches by 12 inches (305 mm×305 mm) by 2.5 mm thick). The layers are stacked such that the glass tin surface of the first glass layer is in contact with the undecorated surface of the decorated polymer sheet, the decorated surface of the decorated polymer sheet in contact with the additional SentryGlas® Plus sheet and the glass tin surface of the second glass layer in contact with the additional SentryGlas® Plus sheet. The glass/decorated polymer sheet/additional SentryGlas® Plus sheet/glass laminate is then placed into a vacuum bag and heated to 90°-100° C. for 30 minutes to remove any air contained between the glass/decorated polymer sheet/additional SentryGlas® Plus sheet/glass laminate to form a pre-press assembly. The pre-press assembly is then subjected to autoclaving, cooling and removal from the autoclave as described in Example 1 to produce an autoclaved glass/decorated polymer sheet/additional SentryGlas® Plus sheet/glass laminate.

### Example 11

Using a pigmented 6-color CMYK+|c|m UV-curable inkset and a UV-curable white ink, available from NUR Microprinters, an image is applied to a 90 mil thick (2.25 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 300%. An adhesive composition consisting of a solution of A-1100 silane (0.05 wt. % based on the total weight of the solution, a product of the Silquest Company, believed to be gamma-aminopropyltrimethoxysilane), isopropanol (66.63 wt. percent based on the total weight of the solution) and water (33.32 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet, an additional SentryGlas® Plus sheet and a glass layer is produced in the following manner. The decorated polymer sheet (12 inches by 12 inches (305 mm×305 mm) and the additional SentryGlas® Plus sheet (12 inches by 12 inches (305 mm×305 mm) by 90 mils thick (2.25 mm)) are conditioned at 23% relative humidity (RH) at a temperature of 72° F. overnight. The laminate is produced by stacking a clear annealed float glass plate layer (12 inches by 12 inches (305 mm×305 mm) by 2.5 mm thick), the decorated polymer sheet layer, the additional SentryGlas® Plus sheet layer and a clear annealed float glass plate layer (12 inches by 12 inches (305 mm×305 mm) by 2.5 mm thick). The layers are stacked such that the glass tin surface of the first glass layer contacts the undecorated surface of the decorated sheet, the decorated surface of the decorated sheet contacts the additional SentryGlas® Plus sheet, and the glass tin surface of the second glass layer contacts the additional SentryGlas® Plus sheet. The glass/decorated polymer sheet/additional SentryGlas® Plus sheet/glass laminate is then placed into a vacuum bag and heated to 90°-100° C. for 30 minutes to remove any air contained between the glass/decorated polymer sheet/additional SentryGlas® Plus sheet/glass laminate layers to form a pre-press assembly. The pre-press assembly is then subjected to autoclaving, cooling and removal from the autoclave as described in Example 1 to produce an autoclaved glass/decorated polymer sheet/additional SentryGlas® Plus sheet/glass laminate.

### Example 12

Using a pigmented 8-color CMYK +|c|m|y|k UV-curable inkset available from NUR Microprinters, an image is applied to a 120 mil thick (3.00 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 600%. An adhesive composition consisting of a solution of A-1100 silane (0.05 wt. % based on the total weight of the solution, a product of the Silquest Company, believed to be gamma-aminopropyltrimethoxysilane), acetic acid (0.01 weight percent based on the total weight of the solution), isopropanol (66.63 wt. % based on the total weight of the solution) and water (33.31 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet, an additional SentryGlas® Plus layer and a second glass layer is produced in the following manner. The decorated polymer sheet (12 inches by 12 inches (305 mm×305 mm)) and the SentryGlas® Plus sheet (12 inches by 12 inches (305 mm×305 mm) by 60 mils thick (1.50 mm)) are conditioned at 23 percent relative humidity (RH) at a temperature of 72° F. overnight. The laminate is produced by stacking a clear annealed float glass plate layer (12 inches by 12 inches (305 mm×305 mm) by 2.5 mm thick), the decorated polymer sheet layer, the additional SentryGlas® Plus sheet layer and a clear annealed float glass plate layer (12 inches by 12 inches (305 mm×305 mm) by 2.5 mm thick). The layers are stacked such that the glass tin surface of the first glass layer contacts the undecorated surface of the decorated sheet, the decorated surface of the decorated sheet contacts the additional SentryGlas® Plus sheet, and the glass tin surface of the second glass layer contacts the additional SentryGlas® Plus sheet. The glass/decorated polymer sheet/additional SentryGlas® Plus sheet/glass laminate is then placed into a vacuum bag and heated to 90°-100° C. for 30 minutes to remove any air contained between the glass/decorated polymer sheet/additional SentryGlas® Plus sheet/glass laminate layers to form a pre-press assembly. The pre-press assembly is then subjected to autoclaving, cooling and removal from the autoclave as described in Example 1 to produce an autoclaved glass/decorated polymer sheet/additional SentryGlas® Plus sheet/glass laminate.

### Example 13

Using the ink set of Example 1, an image is applied to a 60 mil thick (1.50 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 150 percent. An adhesive composition consisting of a solution of A-1100 silane (0.05 weight percent based on the total weight of the solution, a product of the Silquest Company, believed to be gamma-aminopropyltrimethoxysilane), isopropanol (66.63 weight percent based on the total weight of the solution) and water (33.32 weight percent based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to produce a decorated polymer sheet. A glass laminate composed of a glass layer, the decorated polymer sheet and a biaxially oriented poly(ethylene terephthalate) (PET) film layer is produced in the following manner. The decorated polymer sheet (12 inches by 12 inches (305 mm×305 mm)) and the biaxially oriented PET film (12 inches by 12 inches (305 mm×305 mm) by 4 mils thick (0.10 mm)) are conditioned at 23% relative humidity (RH) at a temperature of 72° F. overnight. The laminate is produced by stacking a clear annealed float glass plate layer (12 inches by 12 inches (305 mm×305 mm) by 3 mm thick), the decorated polymer sheet layer, the biaxially oriented PET film layer, a thin Teflon® film layer (12 inches by 12 inches (305 mm×305 mm) and a clear annealed float glass plate layer (12 inches by 12 inches (305 mm×305 mm) by 3 mm thick). The layers are stacked such that the glass tin surface of the first glass layer contacts the undecorated surface of the decorated sheet, the decorated surface of the decorated sheet contacts the biaxially oriented PET film and the glass tin surface of the second glass layer contacts the Teflon® film layer. The glass/decorated polymer sheet/PET film/Teflon® film/glass laminate is then placed into a vacuum bag and heated to 90°-100° C. for 30 minutes to remove any air contained between the glass/decorated polymer sheet/PET film/Teflon® film/glass laminate layers to form a pre-press assembly. The pre-press assembly is then subjected to autoclaving, cooling and removal from the autoclave as described in Example 1 to form an autoclaved glass/decorated polymer sheet/PET film/Teflon® film/glass laminate. Removal of the Teflon® film and the backing glass layer provides the desired autoclaved glass/decorated polymer sheet/PET film laminate.

### Example 14

Using a pigmented 4-color CMYK UV-curable inkset and a UV-curable white ink available from NUR Microprinters, an image is applied to a 90 mil thick (2.25 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 100 percent. An adhesive composition consisting of a solution of A-1100 silane (0.05 wt. % based on the total weight of the solution, a product of the Silquest Company, believed to be gamma-aminopropyltrimethoxysilane), acetic acid (0.01 weight percent based on the total weight of the solution), isopropanol (66.63 wt. % based on the total weight of the solution) and water (33.31 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet and a biaxially oriented poly(ethylene terephthalate) (PET) film layer is produced in the following manner. The decorated polymer sheet (12 inches by 12 inches (305 mm×305 mm)) and the biaxially oriented PET film (12 inches by 12 inches (305 mm×305 mm) by 4 mils thick (0.10 mm)) are conditioned at 23% relative humidity (RH) at a temperature of 72° F. overnight. The laminate is produced by stacking a glass plate layer (12 inches by 12 inches (305 mm×305 mm) by 3 mm thick), the decorated polymer sheet layer, the biaxially oriented PET film layer, a thin Teflon® film layer (12 inches by 12 inches (305 mm×305 mm) and a clear annealed float glass plate layer (12 inches by 12 inches (305 mm×305 mm) by 3 mm thick). The layers are stacked such that the glass tin surface of the first glass layer contacts the undecorated surface of the decorated sheet, the decorated surface of the decorated sheet contacts the PET film and the glass tin surface of the second glass layer contacts the Teflon® film layer. The glass/decorated polymer sheet/PET film/Teflon® film/glass laminate is then placed into a vacuum bag and heated to 90°-100° C. for 30 minutes to remove any air contained between the glass/decorated polymer sheet/PET film/Teflon® film/glass laminate layers to produce a pre-press assembly. The pre-press assembly is then subjected to autoclaving, cooling and removal from the autoclave as described in Example 1 to produce an autoclaved glass/decorated polymer sheet/PET film/Teflon® film/glass laminate. Removal of the Teflon® film and the backing glass layer provides the desired autoclaved green glass/decorated polymer sheet/PET film laminate.

### Example 15

Using a pigmented 8-color CMYK +|c|m|y|k UV-curable inkset available from NUR Microprinters, an image is applied to a 30 mil thick (0.75 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 400 percent. An adhesive composition consisting of a solution of A-1100 silane (0.05 wt. % based on the total weight of the solution, a product of the Silquest Company, believed to be gamma-aminopropyltrimethoxysilane), isopropanol (66.63 wt. % based on the total weight of the solution) and water (33.32 wt. % based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a Solex® green glass layer, the decorated polymer sheet and a biaxially oriented poly(ethylene terephthalate) (PET) film layer is produced in the following manner. The decorated polymer sheet (12 inches by 12 inches (305 mm×305 mm)) and the biaxially oriented PET film layer (12 inches by 12 inches (305 mm×305 mm) by 4 mils thick (0.10 mm) are conditioned at 23% relative humidity (RH) at a temperature of 72° F. overnight. The laminate is produced by stacking a Solex® green glass plate layer (12 inches by 12 inches (305 mm×305 mm) by 3 mm thick), the decorated polymer sheet layer, the biaxially oriented PET film layer, a thin Teflon® film layer (12 inches by 12 inches (305 mm×305 mm) and a clear annealed float glass plate layer (12 inches by 12 inches (305 mm×305 mm) by 3 mm thick). The Solex® green glass/decorated polymer sheet/PET film/Teflon® film/glass laminate is then placed into a vacuum bag and heated to 90°-100° C. for 30 minutes to remove any air contained between the glass/decorated polymer sheet/PET film/Teflon® film/glass laminate layers to form a pre-press assembly. The pre-press assembly is then subjected to autoclaving, cooling and removal from the autoclave as described in Example 1 to form an autoclaved glass/decorated polymer sheet/PET film/Teflon® film/glass laminate. Removal of the Teflon® film and the backing glass layer provides the desired autoclaved glass/decorated polymer sheet/PET film laminate.

### Example 16

Using the ink set of Example 1 an image is applied to a 30 mil thick (0.75 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 50 percent. An adhesive composition consisting of a solution of A-1100 silane (0.05 wt. % based on the total weight of the solution, a product of the Silquest Company, believed to be gamma-aminopropyltrimethoxysilane), isopropanol (66.63 wt. % based on the total weight of the solution) and water (33.32 wt. % based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet, an additional SentryGlas® Plus sheet and a biaxially oriented poly(ethylene terephthalate) (PET) film layer is produced in the following manner. The decorated polymer sheet (12 inches by 12 inches (305 mm×305 mm)), the additional SentryGlas® Plus sheet (12 inches by 12 inches (305 mm×305 mm) by 30 mils thick (0.75 mm)) and the biaxially oriented PET film layer (12 inches by 12 inches (305 mm×305 mm) by 4 mils thick (0.10 mm) are conditioned at 23% relative humidity (RH) at a temperature of 72° F. overnight. The laminate is produced by stacking a clear annealed float glass plate layer (12 inches by 12 inches (305 mm×305 mm) by 2.5 mm thick) the decorated polymer sheet layer, the additional SentryGlas® Plus sheet layer, the biaxially oriented PET film layer, a thin Teflon® film layer (12 inches by 12 inches (305 mm×305 mm) and a clear annealed float glass plate layer (12 inches by 12 inches (305 mm×305 mm) by 3 mm thick). The layers are stacked such that the glass tin surface of the first glass layer contacts the undecorated surface of the decorated sheet, the decorated surface of the decorated sheet contacts additional SentryGlas® Plus sheet and the glass tin surface of the second glass layer contacts the Teflon® film layer. The glass/decorated polymer sheet/additional SentryGlas® Plus sheet/PET film/Teflon® film/glass laminate is then placed into a vacuum bag and heated to 90°-100° C. for 30 minutes to remove any air contained between the glass/decorated polymer sheet/additional SentryGlas® Plus sheet/PET film/Teflon® film/glass laminate layers to form a pre-press assembly. The pre-press assembly is then subjected to autoclaving, cooling and removal from the autoclave as described in Example 1 to form an autoclaved glass/decorated polymer sheet/additional SentryGlas® Plus sheet/PET film/Teflon® film/glass laminate. Removal of the Teflon® film and the backing glass layer provides the desired autoclaved glass/decorated polymer sheet/additional SentryGlas® Plus sheet/PET film/Teflon® film/glass laminate.

### Example 17

Using a pigmented 4-color CMYK UV-curable inkset and a UV-curable white ink available from NUR Microprinters, an image is applied to a 90 mil thick (2.25 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 300 percent. An adhesive composition consisting of a solution of A-1100 silane (0.05 wt. % based on the total weight of the solution, a product of the Silquest Company, believed to be gamma-aminopropyltrimethoxysilane), acetic acid (0.01 wt. % based on the total weight of the solution), isopropanol (66.63 wt. % based on the total-weight of the solution) and water (33.31 wt. % based on the total weight of the solution) is prepared and allowed to sit for at least one hour prior to use. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the silane decorated polymer sheet, an additional SentryGlas® Plus sheet and a biaxially oriented poly(ethylene terephthalate) (PET) film layer is produced in the following manner. The decorated polymer sheet (12 inches by 12 inches (305 mm×305 mm)), the additional SentryGlas® Plus sheet (12 inches by 12 inches (305 mm×305 mm) by 90 mils thick (2.25 mm)) and the biaxially oriented PET film layer (12 inches by 12 inches (305 mm×305 mm) by 4 mils thick (0.10 mm) are conditioned at 23 percent relative humidity (RH) at a temperature of 72° F overnight. The laminate is produced by stacking a clear annealed float glass plate layer (12 inches by 12 inches (305 mm×305 mm) by 2.5 mm thick), the decorated polymer sheet layer, the additional SentryGlas® Plus sheet layer, the biaxially oriented PET film layer, a thin Teflon® film layer (12 inches by 12 inches (305 mm×305 mm) and a clear annealed float glass plate layer (12 inches by 12 inches (305 mm×305 mm) by 3 mm thick). The layers are stacked such that the glass tin surface of the first glass layer contacts the undecorated surface of the decorated sheet, the decorated surface of the decorated sheet contacts additional SentryGlas® Plus sheet and the glass tin surface of the second glass layer contacts the Teflon® film layer. The glass/decorated polymer sheet/additional SentryGlas® Plus sheet/PET film/Teflon® film/glass laminate is then placed into a vacuum bag and heated to 90°-100° C. for 30 minutes to remove any air contained between the glass/decorated polymer sheet/additional SentryGlas® Plus sheet/PET film/Teflon® film/glass laminate layers to form a pre-press assembly. The pre-press assembly is then subjected to autoclaving, cooling and removal from the autoclave as described in Example 1 to form an autoclaved glass/decorated polymer sheet/additional SentryGlas® Plus sheet/PET film/Teflon® film/glass laminate. Removal of the Teflon® film and the backing glass layer provides the desired autoclaved glass/decorated polymer sheet/additional SentryGlas® Plus sheet/PET film/Teflon® film/glass laminate.

### Example 18

Using a pigmented 4-color CMYK UV-curable inkset and a UV-curable white ink available from NUR Microprinters, an image is applied to a 60 mil thick (1.50 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 100 percent. An adhesive composition consisting of a solution of A-1100 silane (0.05 wt. % based on the total weight of the solution, a product of the Silquest Company, believed to be gamma-aminopropyltrimethoxysilane), isopropanol (66.63 wt. % based on the total weight of the solution) and water (33.32 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet, an additional SentryGlas® Plus sheet and a biaxially oriented poly(ethylene terephthalate) (PET) film layer is produced in the following manner. The decorated polymer sheet (12 inches by 12 inches (305 mm×305 mm)), the additional SentryGlas® Plus sheet (12 inches by 12 inches (305 mm×305 mm) by 60 mils thick (1.50 mm)) and the biaxially oriented PET film layer (12 inches by 12 inches (305 mm×305 mm) by 4 mils thick (0.10 mm) are conditioned at 23% relative humidity (RH) at a temperature of 72° F. overnight. The laminate is produced by stacking a clear annealed float glass plate layer (12 inches by 12 inches (305 mm×305 mm) by 2.5 mm thick), the decorated polymer sheet layer, the additional SentryGlas® Plus sheet layer, the biaxially oriented PET film layer, a thin Teflon® film layer (12 inches by 12 inches (305 mm×305 mm) and a clear annealed float glass plate layer (12 inches by 12 inches (305 mm×305 mm) by 3 mm thick). The layers are stacked such that the glass tin surface of the first glass layer contacts the undecorated surface of the decorated sheet, the decorated surface of the decorated sheet contacts additional SentryGlas® Plus sheet and the glass tin surface of the second glass layer contacts the Teflon® film layer. The glass/decorated polymer sheet/additional SentryGlas® Plus sheet/PET film/Teflon® film/glass laminate is then placed into a vacuum bag and heated to 90°-100° C. for 30 minutes to remove any air contained between the glass/decorated polymer sheet/additional SentryGlas® Plus sheet/PET film/Teflon® film/glass laminate layers to form a pre-press assembly. The pre-press assembly is then subjected to autoclaving, cooling and removal from the autoclave as described in Example 1 to form an autoclaved glass/decorated polymer sheet/additional SentryGlas® Plus sheet/PET film/Teflon® film/glass laminate. Removal of the Teflon® film and the backing glass layer provides the desired autoclaved glass/decorated polymer sheet/additional SentryGlas® Plus sheet/PET film laminate.

### Example 19

Using a pigmented 8-color CMYK +|c|m|y|k UV-curable inkset available from NUR Microprinters, an image is applied to a 120 mil thick (3.00 mm) SentryGlas® Plus sheet (a product of the DuPont Company) by ink jet printing with a NUR Tempo® Modular Flatbed Inkjet Press equipped to handle rigid sheet stock (manufactured by NUR Microprinters of Monnachie, N.J.) to provide an ink coverage of 400 percent. An adhesive composition consisting of a solution of A-1100 silane (0.05 wt. % based on the total weight of the solution, a product of the Silquest Company, believed to be gamma-aminopropyltrimethoxysilane), acetic acid (0.01 wt. % based on the total weight of the solution), isopropanol (66.63 wt. % based on the total weight of the solution) and water (33.31 wt. % based on the total weight of the solution) is prepared. A 12-inch by 12-inch piece of the decorated SentryGlas® Plus sheet is dipped into the silane solution (residence time of about 1 minute), removed and allowed to drain and dry under ambient conditions to form a decorated polymer sheet. A glass laminate composed of a glass layer, the decorated polymer sheet, an additional SentryGlas® Plus sheet, and a biaxially oriented poly(ethylene terephthalate) (PET) film layer is produced in the following manner. The decorated polymer sheet (12 inches by 12 inches (305 mm×305 mm)), the additional SentryGlas® Plus sheet (12 inches by 12 inches (305 mm×305 mm) by 120 mils thick (3.00 mm)), and the biaxially oriented PET film layer (12 inches by 12 inches (305 mm×305 mm) by 4 mils thick (0.10 mm) are conditioned at 23% relative humidity (RH) at a temperature of 72° F. overnight. The laminate is produced by stacking a clear annealed float glass plate layer (12 inches by 12 inches (305 mm×305 mm) by 2.5 mm thick), the decorated polymer sheet layer, the additional SentryGlas® Plus sheet, the biaxially oriented PET film layer and a clear annealed float glass plate layer (12 inches by 12 inches (305 mm×305 mm) by 3.0 mm thick). The layers are stacked such that the glass tin surface of the first glass layer contacts the undecorated surface of the decorated sheet, the decorated surface of the decorated sheet contacts additional SentryGlas® Plus sheet and the glass tin surface of the second glass layer contacts the Teflon® film layer. The glass/decorated polymer sheet/additional SentryGlas® Plus sheet/PET film/Teflon® film/glass laminate is then placed into a vacuum bag and heated to 90°-100° C. for 30 minutes to remove any air contained between the glass/decorated polymer sheet/additional SentryGlas® Plus sheet/PET film/Teflon® film/glass laminate layers to form a pre-press assembly. The pre-press assembly is then subjected to autoclaving, cooling and removal from the autoclave as described in Example 1 to form an autoclaved glass/decorated polymer sheet/additional SentryGlas® Plus sheet/PET film/Teflon® film/glass laminate. Removal of the Teflon® film and the backing glass layer provides the desired glass/decorated polymer sheet/additional SentryGlas® Plus sheet/PET film laminate.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A polymer sheet having upper and lower surfaces, having a thickness of at least about 0.25 mm, and comprising a polymer composition having a modulus of between about 20,000 psi (138 MPa) and about 100,000 psi (690 MPa), at least one of said surfaces of said sheet having disposed thereon an image and an adhesive composition, and at least a portion of said adhesive composition being in contact with said image.

2. The polymer sheet of claim 1, said polymer composition having a modulus of between about 25,000 psi (173 MPa) and about 90,000 psi (621 MPa).

3. The polymer sheet of claim 1, said polymer composition having a modulus of between about 30,000 psi (207 MPa) and about 80,000 psi (552 MPa).

4. The polymer sheet of claim 1, wherein said polymer composition comprises one or more of an ethylene acid copolymer or ionomer, a vinyl chloride polymers or copolymer, and a polyurethane.

5. The polymer sheet of claim 1, wherein said polymer composition comprises an ethylene acid copolymer or ionomer.

6. The polymer sheet of claim 1, wherein at least one image is disposed on each of said upper and lower surfaces of said sheet.

7. The polymer sheet of claim 1 wherein said image is disposed on at least ten percent of the surface of at least one of said surfaces of said sheet.

8. The polymer sheet of claim 1 wherein an image is disposed on one surface of said sheet and said adhesive composition is disposed on one hundred percent of said surface.

9. The polymer sheet of claim 1 wherein said wherein said polymer composition comprises an ionomer of an ethylene acid copolymer.

10. The polymer sheet of claim 1 having a thickness of at least about 0.38 mm.

11. The polymer sheet of claim 10 having a thickness of at least about 0.75 mm.

12. The polymer sheet of claim 1 wherein the image is applied using an ink-jet printing device.

13. The polymer sheet of claim 1 wherein the adhesive or primer layer comprises a material selected from the group consisting of gamma-aminopropyltriethoxysilane, N-beta-(aminoethyl)-gamma-aminopropyl-trimethoxysilane and combinations thereof.

14. The polymer sheet of claim 1 wherein the adhesive is a coating having a thickness of about 1.0 mil or less.

15. The polymer sheet of claim 14 wherein the adhesive has a thickness of about 0.5 mil or less.

16. The polymer sheet of claim 15 wherein the adhesive has thickness of 0.1 mil or less.

17. A laminate comprising at least one polymer sheet of claim 1 and at least one other layer.

18. The laminate of claim 17 wherein the at least one other layer has a modulus greater than or equal to the modulus of the polymer sheet.

19. The laminate of claim 17 wherein the at least one other layer has a modulus of less than or equal to the modulus of the polymer sheet.

20. The laminate of claim 17 comprising at least two other layers, wherein at least one of the at least two other layer has a modulus of greater than or equal to the modulus of the polymer sheet, and wherein the polymer sheet is disposed between the at least two other layers, and wherein the at least two other layers are at least partially transparent to incident light.

21. The laminate of claim 20 wherein at least two of the at least two other layers each independently has a modulus of greater than or equal to the modulus of the polymer sheet.

22. The laminate of claim 21 wherein at least one of the at least two other layers comprises glass.

23. The laminate of claim 22 wherein at least two of the at least two other layers is glass and wherein the laminate comprises at least one other polymeric layer disposed between the image-bearing surface of the polymer sheet and at least one of the at least two layers of glass.

24. The laminate of claim 23 wherein the other polymeric layer contacts the surface of the polymer sheet having the image disposed thereon.

25. The laminate of claim 24 wherein said polymer sheet comprises an ethylene acid copolymer or ionomer.

26. The laminate of claim 24 wherein said polymer sheet comprises polyethylene terephthalate.

27. A process for preparing a laminate comprising a decorated polymer sheet comprising the steps of: (1) forming an image-bearing surface on a polymer sheet by applying an image to at least one surface of a polymer sheet having upper and lower surfaces, said sheet having a thickness of at least about 0.25 mm, said polymer having a modulus of between about 20,000 psi (138 MPa) and about 100,000 psi (690 MPa), as determined according to ASTM D 638-03; (2) applying an adhesive composition to at least a portion of said image-bearing surface; and (4) laminating the image-bearing surface to a second layer.

28. The process of claim 27 wherein said polymer sheet comprises an ethylene acid copolymer or ionomer.

29. The process of claim 27 wherein said second layer is an ethylene acid copolymer.

30. The process of claim 29 wherein the laminate is further laminated to a polyethylene terephthalate film.

31. The process of claim 27 wherein said second layer is a sheet of glass, and wherein the laminate is optionally further laminated to a second sheet of glass.
